(19) United States
(12) Patent Application Publication
(10) Pub. No.: US 2022/0011108 A1
(43) Pub. Date: Jan. 13, 2022

(54) COMMUNICATING SURVEY NAIL, TOPOGRAPHICAL GRID, DEVICE AND METHOD FOR RECORDING TOPOGRAPHY AND COMMUNICATING PORTABLE TERMINAL

(71) Applicant: GRTGAZ, Bois Colombes (FR)

(72) Inventors: Michel HARDY, Bois Colombes (FR); Florence LIVREAU, Bois Colombes (FR)

(21) Appl. No.: 17/297,469

(22) PCT Filed: Dec. 19, 2019
(86) PCT No.: PCT/FR2019/053206

§ 371 Date: May 27, 2021

(30) Foreign Application Priority Data
Dec. 20, 2018 (FR) 1873705
Feb. 8, 2019 (FR) 1901291

(51) Int. Cl. G01C 15/04; G01S 1/04; G01S 1/68; G01S 13/87; G01S 5/02; G06K 19/07; H01Q 1/22

(52) U.S. Cl. CPC G01C 15/04; G01S 1/042; G01S 1/68; H01Q 1/2225; G01S 5/02; G06K 19/0701; G01S 13/876

(57) ABSTRACT

The invention relates to a network of communicating survey nails (10) that each comprise an active radiofrequency identification beacon, comprising:
a stand-alone electrical power source for powering a transmitter and a storage means;
the storage means for storing a unique identifier and nail position data;
the transmitter of a radiofrequency signal compliant with an RFID protocol comprising said unique identifier and said nail position data, the transmitter comprising an antenna.

The invention also relates to a device (30) for recording topography, which comprises at least three nails (10) and a georeferencing device (36) comprising:
a first communication means (361) using an RFID protocol, for receiving the radiofrequency signal comprising the unique identifier and the position data of each nail; and
a triangulation means (363) configured to calculate the position of the georeferencing device with respect to the position of the three nails.

### TECHNICAL FIELD OF THE INVENTION

The present invention relates to communicating objects in the form of survey nails, a topographical grid and a device and method for recording topography, and a portable communicating terminal. The present invention applies notably to the field of mapping underground networks.

### STATE OF THE ART

Currently, obtaining a reliable and precise mapping of underground networks is difficult. Equipment available on the market is expensive, bulky and limited in its uses. The lack of reliable and precise mapping can lead to snagging networks during works. Maps of underground networks are key data for the operators of said networks, as well as for all those working on public roadways. In particular, in the case of construction works, a network operator's priorities are the following: knowing the precise position of its network; knowing the precise location of neighboring networks; not damaging either its own or neighboring networks; and optimizing the duration of the work.

Currently, operators utilize expert surveyors to map networks. Once the network has been installed and before filling in the trench (also known as “excavation”), the surveyors record the network's upper generatrix point by point with state-of-the-art equipment.

Surveyors use two methods to achieve centimeter-level accuracy: Differential Global Positioning System (“DGPS”, registered trademark), and Real Time Kinematic (“RTK”).

Differential global positioning uses a network of fixed reference satellite stations that transmit the difference between the position indicated by the satellites and their known actual positions. A network of reference ground stations (also known as “bases”) is installed on the earth's surface by the operator, government agencies, and private companies. The private companies sell the corrections between the position indicated by the satellites and the positions determined by means of the network of ground stations. Differential global positioning technology is very often used in terrestrial and maritime navigation.

Satellites send signals by radio waves to the user's mobile receiver and to reference stations. Each signal received by a reference station is processed by said reference station using, in particular, the phase of the received signal. The position of the satellite transmitting the signal is calculated, as well as a correction between the satellite's position as stated by the satellite and the position calculated by the reference station.

The calculated correction is then sent to the mobile receiver by radio waves. The mobile receiver can determine its precise position based on the signals obtained from the satellites and the corrections.

The DGPS method has made it possible to significantly increase the precision of the geolocation positioning, which went from ten to fifteen meters to a precision of three to five meters. The DGPS method works on a local scale and the calculated corrections are only valid in the vicinity of the reference station that transmitted the calculated corrections.

The RTK method use the same differential correction method as that previously explained for DGPS. The difference between the two methods is that the signal transmitted by the satellites is not processed in the same manner and the position correction is based on the carrier phase of the geolocation signal in the RTK method. In the RTK method, the signal processing utilized makes it possible to have precision of the order of one centimeter, therefore much greater than with the DGPS method.

The operators outsource a skill that is not the network operators' core business. The equipment currently in use reaches centimeter-level accuracy, as required by standards. Unfortunately, the services provided by surveyors are costly, their availability often hinders the progress of worksites, and the equipment used to reach precision of the order of one centimeter is costly. In addition, the devices' performance depends on the environment. In urban areas, there may be “urban canyon” zones, which the signals coming from the satellites cannot reach because, in particular, of the height of some buildings.

A topography recording of a network comprises measuring a planimetric and altimetric position of the network's upper generatrix, and a plan background, ie the representation in a two-dimension plane of the measurement of a planimetric and altimetric position of the surface environment in the vicinity of the network. It has been observed that the plans of the various operators may be different, for example with regard to the scales, reference point and precision of the measurements. A foreperson may encounter difficulty in concatenating the various plans and reading errors may occur. Incorporating the data in a geographic information system (“GIS”) may lead to errors caused, for example, by the conversion formulas.

American Patent application US2012/326 872, which discloses passive nails comprising a geolocation chip, is known. These nails have a particular shape and make it possible to prevent a landowner from granting itself a portion of land that does not belong to it by moving the nails marking out its land.

American patent application US 2006/220 995, which discloses a communicating survey nail and a determination means for determining a geographic position based on the position of survey nails, is also known.

Similar nails are also disclosed in patent applications US 2010/295 699, EP 2 040 031 and WO 2006/105 381, which disclose survey nails that are passive or fitted with a constantly operating battery.

### DESCRIPTION OF THE INVENTION

The present invention aims to remedy all or part of these drawbacks.

To this end, according to a first aspect, the present invention envisages a communicating survey nail, which comprises:
an active radiofrequency identification beacon comprising:
a stand-alone electrical power source for powering a transmitter and a storage means;
the storage means for storing a nail's unique identifier and position data; and
the transmitter of a radiofrequency signal according to a radiofrequency identification (“RFID”) protocol comprising said unique identifier and said position data of the nail, the transmitter comprising an antenna for broadcasting and receiving the signal; and
a switch to activate/deactivate the beacon.

Thanks to these provisions, beacons, also known as nails, are installed at several places on the sidewalk. At the time of installation, a topography recording is made for each of the nails, and a reading of the nail's position, georeferenced along three dimensions, is taken and recorded in the beacon installed in the nail. Once initialized, the operation of the nails that are the subject of the present invention do not depend on any communication with satellites to enable a precise location in a repository. In addition, these devices are inexpensive. The switch makes it possible to keep the beacon's electricity consumption down if no reading is taken.

In some embodiments, the activation/deactivation switch comprises two positions, one for activating the beacon and the other for deactivating the beacon.

These embodiments make it possible to keep the beacon activated or deactivated.

In some embodiments, the activation/deactivation switch is a magnetic switch.

In some embodiments, the activation/deactivation switch is a switch controlled by radiofrequency waves.

The advantage of these embodiments is that they activate and deactivate the beacon remotely.

In some embodiments, the activation/deactivation switch is a switch controlled by touch.

In some embodiments, the survey nail that is the subject of the present invention comprises a determination means for determining a duration since a signal was last transmitted by the transmitter and, if the determined duration is above a predefined limit value, the beacon is deactivated.

These embodiments make it possible to deactivate the beacon automatically when no reading is taken, to avoid using the electrical energy from the stand-alone electrical power source to no purpose.

According to a second aspect, the present invention envisages a topographical grid, which comprises at least three nails that are the subject of the present invention.

As the particular aims, advantages and features of the grid that is the subject of the present invention are similar to those of the nail that is the subject of the present invention, they are not repeated here.

Furthermore, since the position of the nails is known, superimposition of separate plans is facilitated by superimposition of the grid of nails. These embodiments make it possible for all service providers working on the underground network of the public roadway to have access to a dynamic and unique grid, or network, of nails to project mapping data locally onto the grid.

According to a third aspect, the present invention envisages a georeferencing device that comprises:
a boom, one extremity of which is placed in position near a topographical element;
a first communication means for communicating with at least three nails that are the subject of the present invention, using an RFID protocol and being configured to receive the radiofrequency signal comprising each nail's unique identifier and position data; and
a measurement means for measuring at least one physical dimension representative of each radiofrequency signal received;
a triangulation means that calculates the position of the extremity of the boom with regard to the position of said at least three nails and each physical dimension measured, the calculated position of the georeferencing device being transmitted by a second communication means to a portable communicating terminal; and
said second communication means (364) transmitting the calculated position.

Thanks to these provisions, the position of a georeferencing device is determined in real time without requiring satellites and with greater precision. In addition, the grid can be built up progressively by adding nails when roadways are being worked on.

In some embodiments, the first communication means comprises a measurement means for measuring at least one physical dimension representative of each radiofrequency signal received, and the triangulation means calculates the position of the extremity of the boom with respect to the position of said at least three nails and at least one measured physical dimension.

These embodiments make it possible to improve the precision of the position calculation.

In some embodiments, the measurement means is configured to measure at least one physical dimension among the following physical dimensions: AOA (Angle of Arrival); TDOA (Time Difference Of Arrival); RSSI (Received Signal Strength Indication); SNR (Signal to Noise Ratio).

These embodiments make it possible to use parameters linked to the signal itself, independently of its content, to improve the determination of the position of the georeferencing device with respect to the nails.

In some embodiments, the device also comprises a modification means for changing the position of at least one switch to the activation position.

These embodiments make it possible to activate the nails for georeferencing and therefore to keep the energy consumption of said nails down.

In some embodiments, the first communication means comprises a measurement means for measuring at least one physical dimension representative of each radiofrequency signal received, and the triangulation means calculates the position of the georeferencing device with respect to the position of said at least three nails and at least one measured physical dimension.

According to a fourth aspect, the present invention envisages a topography recording method for a device that is the subject of the present invention, which comprises the following steps:
emission by at least three survey nails that are the subject of the present invention of a radiofrequency signal, compliant with an RFID protocol, that comprises the nail's unique identifier and position data;
reception of each nail's position data and unique identifier;
triangulation to calculate the position of a georeferencing device with respect to the position of at least three nails.

In some embodiments, the method that is the subject of the present invention also comprises a step of measuring at least one physical dimension representative of each radiofrequency signal received and wherein the triangulation step calculates the position of the georeferencing device with respect to the position of said at least three nails and at least one measured physical dimension.

As the particular aims, advantages and features of the method that is the subject of the present invention are similar to those of the device that is the subject of the present invention, they are not repeated here.

In some embodiments, the method that is the subject of the present invention comprises a step of reception by a portable communicating terminal of the calculated position of the georeferencing device, and a step of displaying the position of the georeferencing device with respect to the position of each nail.

These embodiments make it possible for an operator to view the grid and the position of a topographical element quickly and easily.

According to a fifth aspect, the present invention envisages a communicating portable terminal comprising a means for communicating with a georeferencing device that is the subject of the present invention.

As the particular aims, advantages and features of the method that is the subject of the present invention are similar to those of the device that is the subject of the present invention, they are not repeated here.

The various aspects and particular features of the present invention are intended to be combined together so that a communicating survey nail makes it possible to produce a topographical grid using a georeferencing device and utilizing a topography recording method.

### BRIEF DESCRIPTION OF THE FIGURES

Other particular advantages, aims and features of the invention will become apparent from the non-limiting description that follows of at least one particular embodiment of the communicating survey nail, of the topographical grid, and of the device and method for recording topography that are the subjects of the present invention, with reference to drawings included in an appendix, wherein:

FIG. 1 represents, schematically, a first particular embodiment of the nail that is the subject of the present invention;

FIG. 2 represents, schematically, a first particular embodiment of the grid that is the subject of the present invention;

FIG. 3 represents, schematically, a first particular embodiment of the system comprising a device that is the subject of the present invention; and

FIG. 4 represents, schematically and in the form of a logical diagram, a series of particular steps of the method that is the subject of the present invention;

### DESCRIPTION OF EXAMPLES OF REALIZATION OF THE INVENTION

The present description is given in a non-limiting way, in which each characteristic of an embodiment can be combined with any other characteristic of any other embodiment in an advantageous way.

Note that the figures are not to scale.

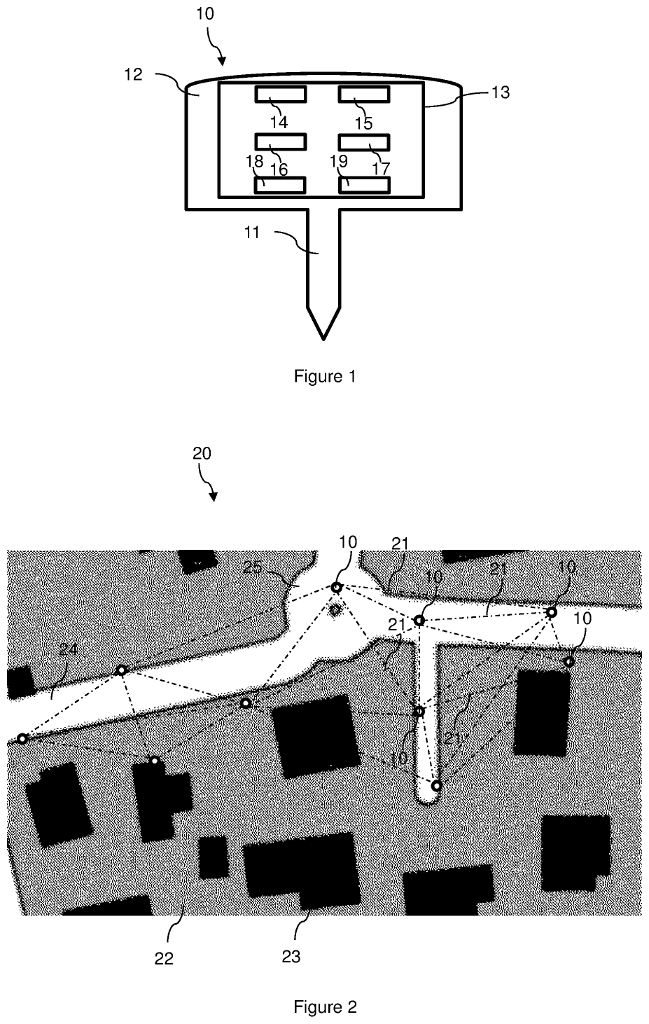

FIG. 1, which is not to scale, shows a schematic view of an embodiment of the nail 10 that is the subject of the present invention.

The nail 10 has a head 12 and a body 11. The nail 10 is, for example, a survey nail, also known as a surveyor's nail.

The nail 10 comprises an active RFID beacon 13 comprising:
a stand-alone electrical power source 14 for powering a transmitter and a storage means;
the storage means 15 for storing a unique identifier and position data for a nail; and
the transmitter 16 of a radiofrequency signal, according to an RFID protocol comprising said unique identifier and said position data of the nail, the transmitter comprising a signal broadcast and reception antenna 19.

Reminder: an RFID beacon is fitted with a battery and can transmit a signal compliant with an RFID protocol. An active RFID tag can initialize the communication with the receiver by transmitting its unique identifier; the receiver can then respond with a command to confirm the start of the dialog.

More generally, a communication may be achieved by a quasi-continuous emission coming from an active radio identification beacon, for example a nail 10, and a permanent monitoring by the receiver device, for example a georeferencing device 30.

The active RFID beacon 13 comprises a stand-alone electrical power source 14 supplying the beacon 13 to power the storage means 15 and the transmitter 16 of a radiofrequency signal. The stand-alone electrical power source 14 is, for example, a cell or a battery. The stand-alone electrical power source can be any means known to the person skilled in the art.

The RFID beacon 13 is active when the beacon transmits the unique identifier and the position data of the nail 10 to a georeferencing device 36. The RFID beacon 13 is passive when the position data of the nail 10 is written into the storage means 15 by means of a communicating terminal 35, for example utilizing Near Field Communication (“NFC”).

The storage means 15 can be any type of storage means known to the person skilled in the art. Preferably, the storage means 15 comprises a portion that can be overwritten at least once, in which the nail's position data is stored. The storage means 15 also comprises a portion that cannot be overwritten, comprising the nail's unique identifier. The position data of the nail 10 is preferably obtained by means of the DGPS or RTK technology at the time the nail 10 is installed.

The transmitter 16 is configured to communicate according to an RFID protocol by means of an antenna 19. Preferably, the transmitter 16 is configured to speak first (“Tag Talk First”/“TTF”), ie, when the beacon 13 detects a georeferencing device 36, the beacon transmits the signal with no prior prompt; this data can then be transmitted to a portable terminal by the georeferencing device 36.

According to a preferred embodiment, the portable terminal comprises at least one of the two following terminals: a first terminal 35 that handles the communication with the georeferencing device 36; and a second terminal that performs the communicating terminal function and is fitted with an RFID reader for writing to the storage means 15 of at least one nail 10. In addition, the portable terminal may comprise a third terminal that comprises a display means for displaying plans. In some embodiments, the display means can be incorporated into the first terminal 35 or into the georeferencing device 36.

In some embodiments, the transmitter 16 and the associated antenna 19 is a transmitter-receiver configured to receive an item of position data of the nail 10 and to transmit it to the storage means 15, which writes it into memory.

In other embodiments, the beacon 13 comprises a means for communicating with a second portable terminal for the second portable terminal to write a piece of information in the memory of the storage means 15. The second portable terminal may be distinct from the first communicating portable terminal 35. The second portable terminal is preferably fitted with an RFID reader that enables writing to the storage means 15. The second portable terminal may comprise an RFID reader to write the coordinates recorded by a surveyor at the time the nail 10 is installed.

The nail 10 comprises an activation/deactivation switch 17 for activating/deactivating the beacon 13. The switch 17 is configured to inhibit the supply of electrical power to the beacon 13 when in the deactivation position. In this way, the switch makes it possible to avoid consuming the electrical power of the stand-alone electrical power source 14 if no georeferencing measurement is performed.

In some embodiments, the activation/deactivation switch 17 is a magnetic switch, or a switch controlled by radiofrequency waves or by touch. A magnetic switch comprises two positions, one for activating and the other for deactivating the beacon 13, with the switching being controlled by magnetic waves. A switch controlled by radiofrequency waves is a switch comprising two positions, one for activating and the other for deactivating the beacon 13, with the switching being controlled by radiofrequency waves. A switch controlled by touch is a switch comprising two positions, one for activating and the other for deactivating the beacon 13, with the switching being controlled by touch, for example by a finger, or by a mechanical action on the switch.

When the activation/deactivation switch 17 is a magnetic switch or controlled by radiofrequency waves, it makes it possible to activate or deactivate the beacon 13 in the vicinity of the beacon 13 without handling the beacon, especially when the beacon 13 cannot be reached by the operator.

When the nail can be reached by the operator, an activation/deactivation switch 17 controlled by touch by an object communicating by Near Field Communication (“NFC”) or by physical contact, for example utilizing a key, may be used. An object utilizing near field communication is a mobile phone or a digital tablet, for example. These embodiments make it possible to keep the use of power down.

A switch controlled by radiofrequency waves may be a switch responding to a command supplied in a radiofrequency signal, such as an ultra-high frequency RFID (“UHF RFID”) signal. Thanks to these provisions, a nail 10 can be activated or deactivated from far away, which requires a terminal controlling the nail to be powerful, with a large antenna. In this way, the nails can be activated remotely, but this method requires a special appliance, which surveyors may not have available.

Preferably, the nail 10 comprises a determination means 18 for determining a duration since a signal was last transmitted by the transmitter 16 and, if the determined duration is above a predefined limit value, the beacon 13 is deactivated.

The determination means 18, for example a microprocessor, is supplied with electrical power by the stand-alone electrical power source 14 when the switch 17 is in the activation position. The determination means 18 comprises an internal clock and utilizes a program for determining the elapsed duration. Then, a calculation means of the determination means calculates the elapsed duration since the start of the timestamping, and a comparison means of the determination means compares the duration to a predefined limit value memorized in the storage means 15. The predefined limit value is, for example, ten hours.

In some embodiments, the predefined limit value can be changed, for example by receiving a signal through the antenna 19 connected to the transmitter 16, when the transmitter is a transmitter-receiver, or by communication with the second portable terminal.

When the duration since the timestamping is above the predefined limit value, the beacon 13 is deactivated and, preferably, the switch 17 changes to the position corresponding to the deactivation of the beacon 13.

In other embodiments, the determination means 18 comprises a timer that is reset to zero at each activation by the switch 17. When the timed duration exceeds the predefined limit value, the beacon 13 is deactivated. The determination means 18 determines whether the limit value has been exceeded.

FIG. 2 shows a first embodiment of topographical grid 20, which comprises at least three nails 10 that are the subject of the present invention.

FIG. 2 represents a map of an urban environment 22 in which buildings 23, as well as roads 24 and a traffic circle 25 between these roads, are arranged.

Several nails 10 are shown, for example on a sidewalk or near a building 23. The nails 10 can be positioned during road or building works and their position memorized in the storage means 15 of said nail 10 when it is placed in position.

Putting the nail 10 in position follows the following method:
installing the nail;
georeferencing the nail using means known to the person skilled in the art;
memorizing the georeferenced position of the nail in the storage means 15 of the nail.

Preferably, the distance 21 between three nails 10 is such that, when an operator positions himself at any point between the three nails 10, the operator is within receiving range of radiofrequency signals transmitted by said three nails 10.

Preferably, the grid 20 is such that at each point of the public roadway, an operator equipped with a georeferencing device 36 captures at least three radiofrequency signals transmitted by different nails 10.

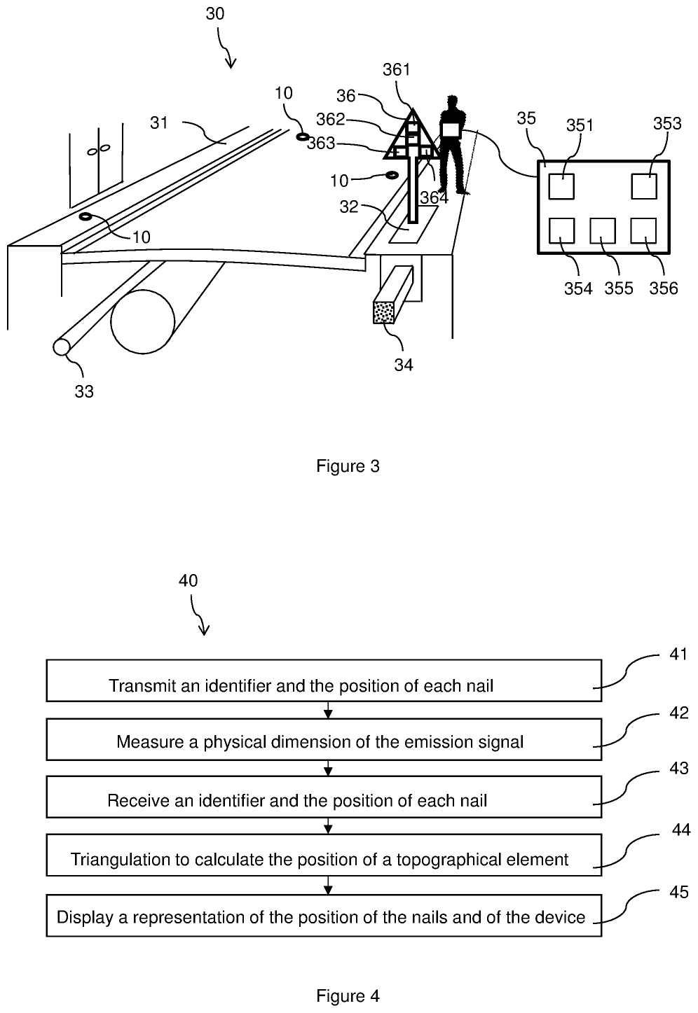

FIG. 3 shows a particular embodiment of the topography recording system 30, which comprises:
at least three nails 10;
a georeferencing device 36 comprising:
   a first communication means 361 for communicating with at least three nails, communicating in accordance with an RFID protocol and being configured to receive the radiofrequency signal comprising the unique identifier and the position data of each nail 10; and
   a triangulation means 363 configured to calculate the position of the georeferencing device 36 with respect to the position of said at least three nails 10, the calculated position of the georeferencing device 36 being transmitted by a second communication means 364 to a portable communicating terminal 35.

Preferably, the position of the georeferencing device 36 is transmitted to the first communicating portable terminal 35 by the second communication means 364; the second communication means 364 may be wired or not. FIG. 3 represents a cross-section view of a roadway 31. The roadway 31 comprises a road in between, on either side, sidewalks and buildings. The roadway 31 can be any type of roadway known to the person skilled in the art. A network 33 is buried under the roadway. The network 33 is, for example, a water or gas supply or drainage network, or any other underground network known to the person skilled in the art. A network 34 is buried under a sidewalk. The network 34 is, for example, an electricity or telephone network, or any other underground network known to the person skilled in the art.

The roadway 31 is fitted with nails 10, on a sidewalk or near buildings. The nails are positioned as described above with regard to FIG. 2.

The sidewalk has an inspection port or excavation 32 through which the underground network 34 is visible.

The operator can calculate the position of the underground network 34 and represent it on a plan by means of the system 30 that is the subject of the present invention.

The georeferencing device 36 comprises the first communication means 361 for communicating by RFID. Preferably, the first communication means 361 receives the position data and unique identifier associated with at least three nails 10. In some embodiments, the first communication means 361 receives an item of position data of each nail 10 within range of the georeferencing device 36.

The first communication means 361 comprises preferably a receiver of radiofrequency signals according to an RFID protocol.

The second communication means 364 has any means for communication with a first wireless or wired communicating portable terminal 35 known to the person skilled in the art, for example, utilizing Bluetooth (registered trademark), compliant with the IEEE 802.11 protocol known as Wi-Fi (registered trademark), or RFID utilizing at least one of the communication protocols of standard IEEE 805.15.4 commonly called Zigbee (registered trademark), Lifi (registered trademark), optical or acoustical.

Preferably, the georeferencing device 36 comprises a measurement means 362 for measuring at least one physical dimension representative of each radiofrequency signal received, for example direction and strength data for a received signal. The measurement means 362 is configured to measure at least one physical dimension among the following physical dimensions:
the angle of arrival (“AOA”) of at least one signal;
the signal's time difference of arrival (“TDOA”);
the received signal strength indication (“RSSI”); and/or
the signal-to-noise ratio (“SNR”).

Each measurement taken is transmitted to the first communicating portable terminal 35 by the second communication means 364.

The first communicating portable terminal 35 comprises a wired or wireless communication means 351 associated with the second communication means 364 of the georeferencing device 36 according to means known to the person skilled in the art.

The georeferencing device 36 comprises a triangulation means 363, which comprises:
a detection means for detecting an angle formed between three nails 10 and the georeferencing device 36 based on the items of position data received from each said nail 10 and, in some embodiments, based on at least one physical dimension associated with the signal;
a calculation means for calculating the distance between the said three nails 10 based on the items of position data received from each said nail 10; and
a calculation means for calculating the position of the georeferencing device 36 based on the angle formed and the calculated distance.

Preferably, the georeferencing device 36 comprises a boom fitted with a radar. The radar comprises an antenna able to detect the signals transmitted by the nails 10 and, preferably, to detect the signal's direction of transmission for each nail 10 and the strength of said signal.

By putting the boom of the georeferencing device 36 in contact with the topographical element 34 whose position is to be determined, the position of the georeferencing device 36 is the same as the position of the topographical element 34, for example an underground network.

For example, the triangulation means 363 is an electronic circuit configured to run a triangulation computer program.

Preferably, the triangulation means 363 calculates the position of the georeferencing device with respect to each triplet of nails 10 whose position has been received. The triangulation means 363 then determines a mean position with respect to the different calculated positions. The triangulation means 363 transcribes the direction and strength data from the boom into X′, Y′ and Z′ coordinates corresponding to the position of one leg of the boom. In some embodiments, the triangulation means 363 calculates the position of the leg of the boom of the georeferencing device 36 with respect to the position of the said at least three nails and of each measured physical dimension.

In some embodiments, the portable communicating terminal 35 comprises a display means 353 for displaying a representation of the position of each nail 10 and of at least one topographical element 34 materialized by the leg of the boom of the georeferencing device. The display means 353 is preferably a screen, possibly a touchscreen. The display means 353 makes it possible for an operator to see the position of the network directly on a map or a plan, for example.

In some embodiments not shown, the triangulation means is incorporated into the communicating portable terminal 35.

In some embodiments, the first communicating portable terminal 35 comprises a means for capturing at least one image, such as a digital camera. In these embodiments, the display means 353 is an augmented reality or virtual reality means for displaying the captured image. The captured image can be supplemented by a plan displayed superimposed over the captured image.

Preferably, the first communicating portable terminal 35 also comprises a representation means 354 for representing a grid based on the position received from each nail. The representation means 354 is configured to automatically enhance a plan representative of the topography in the vicinity of the operator. The plan may be georeferenced. For example, the representation means 354 is an electronic circuit configured to run a computer program.

Preferably, the representation means 354 of a grid comprises:
an update means 356 for updating a representation of a grid 20 based on an item of position data of said nail or said topographical element.

The georeferencing device 36 compares the data from the representation of the grid 20 to each position of a nail 10 whose position is defined by the operator.

Then, if the nail 10 or the topographical element 34 is not represented in the representation of the grid at the received position, the update means 356 updates the representation with the new data.

For example, the detection means 355 and the update means 356 are electronic circuits configured to run a computer program.

Preferably, an electronic circuit configured to run a program comprises the representation means 354, the detection means 355 and the update means 356.

In some embodiments, the georeferencing device 36 comprises a modification means for changing the position of at least one switch 17 to the activation position. The modification means for changing the position of at least one switch is any means corresponding to the switches 17 described above, for example a communication means for communicating by radiofrequency, magnetic or NFC waves.

FIG. 4 shows a particular embodiment of the method 40 that is the subject of the present invention.

The topography recording method 40 comprises the following steps:
emission 41 by at least three communicating survey nails 10 of a radiofrequency signal compliant with an RFID protocol, comprising the unique identifier and the position data of the nail;
reception 43 of an item of position data and unique identifier of each nail 10;
triangulation 44 to calculate the position of a georeferencing device 36 with respect to the position of at least three nails 10.

In some embodiments, the method 40 also comprises a measurement step 42 of measuring at least one physical dimension representative of each radiofrequency signal received and wherein the triangulation step 44 calculates the position of the georeferencing device 36 with respect to the position of said at least three nails 10 and at least one measured physical dimension.

In some embodiments, the method 40 comprises a step of transmitting the position of the georeferencing device 36 to the portable terminal 35. The transmission can utilize the Bluetooth protocol or a wired connection.

In some embodiments, the method 40 comprises a display means 45 for displaying a representation of the position of each nail 10 and of at least one topographical element 34. The display step is preferably carried out by the portable terminal 35.

In some embodiments, the method 40 comprises at least one of the following steps:
representation 42 of a grid based on the received position of each nail 10;
communication 45 with a nail 10 or a topographical element 34 whose representation is missing from the representation of the grid; and
updating a representation of a grid based on an item of position data of said nail 10 or said topographical element 34.

In some embodiments, the method 10 comprises a step of activating at least three beacons of nails 10.

The operation of this method 40 is carried out, for example, by utilizing the nail 10 and the device 30, as described with regard to FIGS. 1 and 3, with all the variants and embodiments of the nail 10 and device 30 being able to be transposed in the form of steps of the method 40.

1. Communicating survey nail, comprising:
an active RFID beacon comprising:
a stand-alone electrical power source for powering a transmitter and a storage means;
the storage means for storing a unique identifier and nail position data; and
the transmitter of a radiofrequency signal compliant with an RFID protocol comprising said unique identifier and said position data of the nail, the transmitter comprising a signal broadcast and reception antenna; and
an activation/deactivation switch of the beacon.

2. The nail according to claim 1, wherein the activation/deactivation switch comprises two positions, one for activating the beacon and the other for deactivating the beacon.

3. The nail according to claim 1, wherein the activation/deactivation switch is a magnetic switch.

4. The nail according to claim 1, wherein the activation/deactivation switch is a switch controlled by radiofrequency waves.

5. The nail according to claim 1, wherein the activation/deactivation switch is a switch controlled by touch.

6. The nail according to claim 1, which comprises a determination means for determining a duration since a signal was last transmitted by the transmitter and, if the determined duration is above a predefined limit value, the beacon is deactivated.

7. Topographical grid, which comprises at least three nails according to claim 1.

8. Georeferencing device, which comprises:
a boom, one extremity of which is placed in position near a topographical element;
a first communication means for communicating with at least three nails according to claim 1, communicating by an RFID protocol and being configured to receive the radiofrequency signal comprising the unique identifier and the position data of each nail; and
a measurement means for measuring at least one physical dimension representative of each radiofrequency signal received;
a triangulation means that calculates the position of the extremity of the boom with regard to the position of said at least three nails and each physical dimension measured, the calculated position of the georeferencing device being transmitted by a second communication means to a portable communicating terminal; and
said second communication means transmitting the calculated position.

9. Device according to claim 8, wherein the first communication means comprises a measurement means for measuring at least one physical dimension representative of each radiofrequency signal received and the triangulation means calculates the position of the extremity of the boom with respect to the position of said at least three nails and at least one measured physical dimension.

10. The device according to claim 9, wherein the measurement means is configured to measure at least one physical dimension among the following physical dimensions: AOA (Angle of Arrival); TDOA (Time Difference Of Arrival); RSSI (Received Signal Strength Indication); SNR (Signal to Noise Ratio).

11. The device according to claim 8, which also comprises a modification means for changing the position of at least one switch to the activation position.

12. A topography recording method, comprising the following steps:
emission by at least three communicating survey nails according to claim 1 of a radiofrequency signal utilizing an RFID protocol, comprising the nail's unique identifier and position data;
reception of each nail's position data and unique identifier;
triangulation to calculate the position of a georeferencing device with respect to the position of at least three nails.

13. The method according to claim 12, which also comprises a measurement step for measuring at least one physical dimension representative of each radiofrequency signal received and wherein the triangulation step calculates the position of the georeferencing device with respect to the position of said at least three nails and at least one measured physical dimension.

14. The method according to claim 12, which comprises a step of reception by a portable communicating terminal of the calculated position of the georeferencing device, and a step of displaying the position of the georeferencing device with respect to the position of each nail.

15. A portable communicating terminal characterized in that it comprises a communication means with a georeferencing device according to claim 8.
